(19) United States
(12) Patent Application Publication
(10) Pub. No.: US 2009/0038166 A1
(43) Pub. Date: Feb. 12, 2009

(54) SHARP UNDERCUTTER AND UNDERCUTTER FABRICATION

(75) Inventors: Trevor John Crichton, Bucks (GB); Terence Gordon Royle, Hampshire (GB)

Correspondence Address: THE PROCTER & GAMBLE COMPANY;Global Legal Department - IP, Sycamore Building - 4th Floor, 299 East Sixth Street, CINCINNATI, OH, 45202, US

(73) Assignee: THE GILLETTE COMPANY, Boston, MA (US)

(21) Appl. No.: 11/658,298

(22) PCT Filed: Jul. 21, 2005
(86) PCT No.: PCT/US2005/025872

§ 371 Date: Aug. 25, 2008

(51) Int. Cl. B26B 19/04

(52) U.S. Cl. 30/346.51; 76/115

(57) ABSTRACT

This invention employs a serrated or scalloped edge (7) on the undercutter of an electric razor to enhance the shaving performance. This improvement is achieved by promoting hair capture and retention and reducing the cutting forces required to sever the hair. The serrations and/or scallops (9) help retain the captured hair, thereby increasing hair cutting efficiency. They also reduce the tendency for the hair to “roll” along the edge of the foil aperture until it is trapped in the aperture angle; this promotes a closer shave. A serrated edge can be generated by various methods. In this disclosure, several possible methods are described. The preferred method of fabrication is to generate a weld bead on the outer surface of an undercutter blade and grind back the bead to generate sharp edges along the weld bead. In doing so, the weld bead produces a serrated pattern. The geometry of the serration is determined by the geometry of the weld bead.

The present invention relates to cutter assemblies for dry shavers, undercutters for dry shavers, and methods of manufacturing undercutters.

A conventional undercutter for dry shaving has a plurality of arcuate blade elements each having a part-annular circular edge substantially at right angles with the major surfaces of the cutter element. When used in dry shaving, in cooperation with a foil-type outer cutter, hairs are cut essentially by a shearing action between the foil and the undercutter. Whilst this works satisfactorily for its intended purpose, the efficiency of shaving is capable of improvement in order to reduce the time required to achieve a satisfactory clean shave.

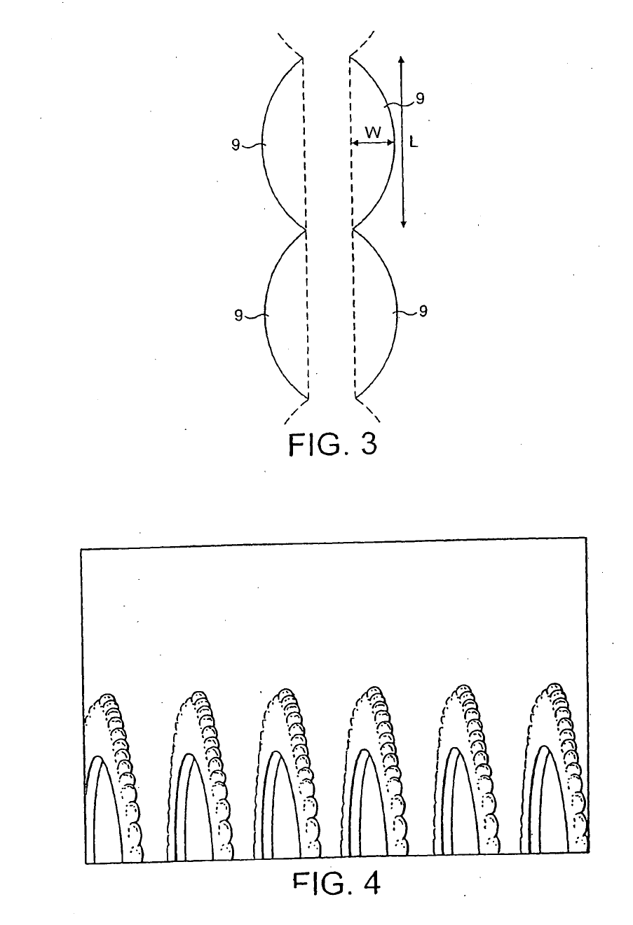

U.S. Pat. No. 4,589,205 (Tanahashi) discloses an undercutter blade whose profile can have spherical indents (FIG. 5) where the angle along each cutting edge is constant, at 90 degrees. Other profiled undercutter blades are known from U.S. Pat. No. 4,044,636 (Kolodziej), U.S. Pat. No. 5,214,833 (Yada) and WO 03/022535 (Otani et al.). The Yada reference discloses in FIGS. 2-4 a single arcuate indent 39 on each individual blade 30 along an outer peripheral edge 37 so as to form a sharp cutting edge 41 of the outer peripheral edge 37.

However, in all these prior proposals the basic cutting mechanism remains unchanged, i.e. a shearing action between foil and undercutter.

It has never previously been possible in an economic way to produce a satisfactory undercutter having sharp cutting edges so that a significant proportion of beard hairs may be severed more efficiently by a slicing action or a combined slicing/shearing action.

An object of the invention is to increase the efficiency of dry shaving without sacrificing comfort.

Another object of the invention is to improve hair capture, retention and cutting.

According to one aspect of the invention, there is provided an undercutter for a dry shaver comprising a plurality of blade elements, each having a blade element edge, wherein at least one blade element edge has a plurality of successive lateral protrusions defining valleys therebetween, and an acute cutting edge within each valley.

According to another aspect of the invention, there is provided a cutter assembly for a dry shaver, comprising: an outer cutter having a plurality of hair receiving apertures; and an undercutter according to said one aspect mounted for movement relative to the outer cutter and having a plurality of blade elements.

According to another aspect of the invention, there is provided a method of manufacturing the undercutter defined above.

For a better understanding of the invention, and to show how the same may be carried into effect, reference will now be made, by way of example, to the accompanying drawings, in which:

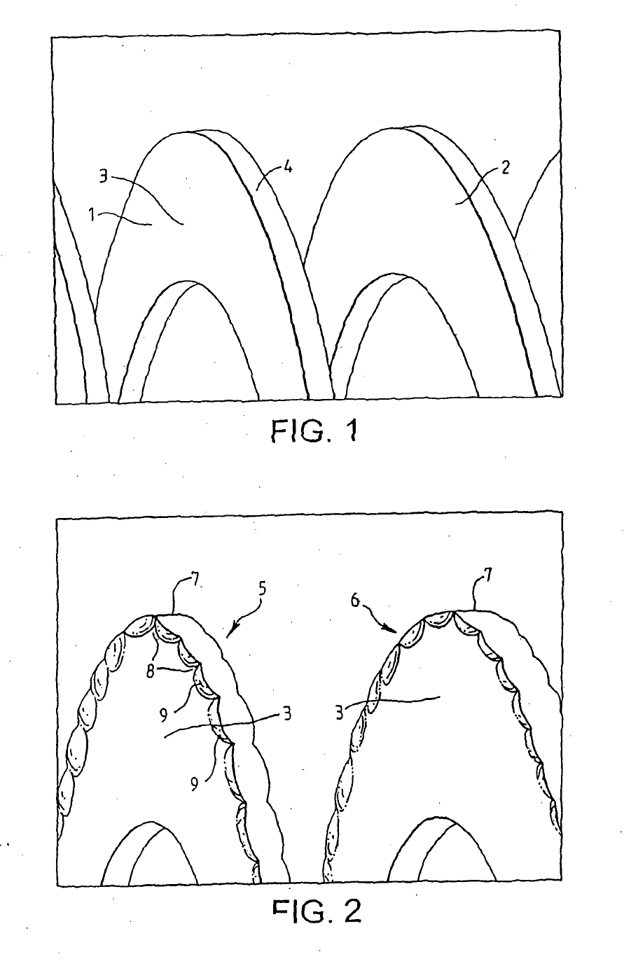

FIG. 1 shows blade elements of a standard Flex Integral, UltraSpeed undercutter (Model 6016) manufactured by Braun AG;

FIG. 2 shows blade elements of an undercutter according to an embodiment of the invention;

FIG. 3 shows a schematic diagram of part of an edge of one of the blade elements of FIG. 2;

FIG. 4 shows weld beading along blade edges of the undercutter of FIG. 1.;

FIG. 5 shows a jig for holding an undercutter during bead formation;

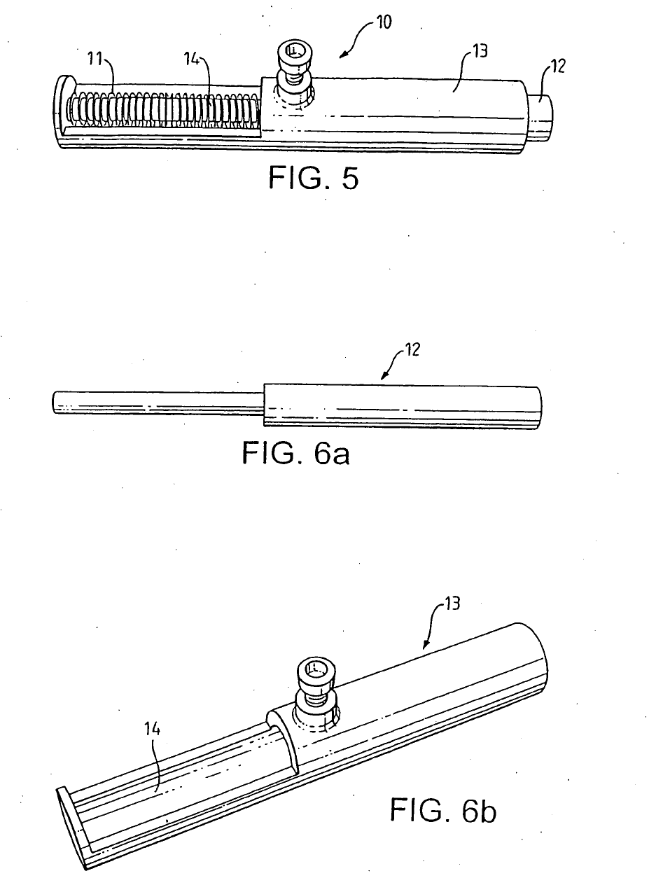

FIG. 6 shows an exploded view of the jig of FIG. 5;

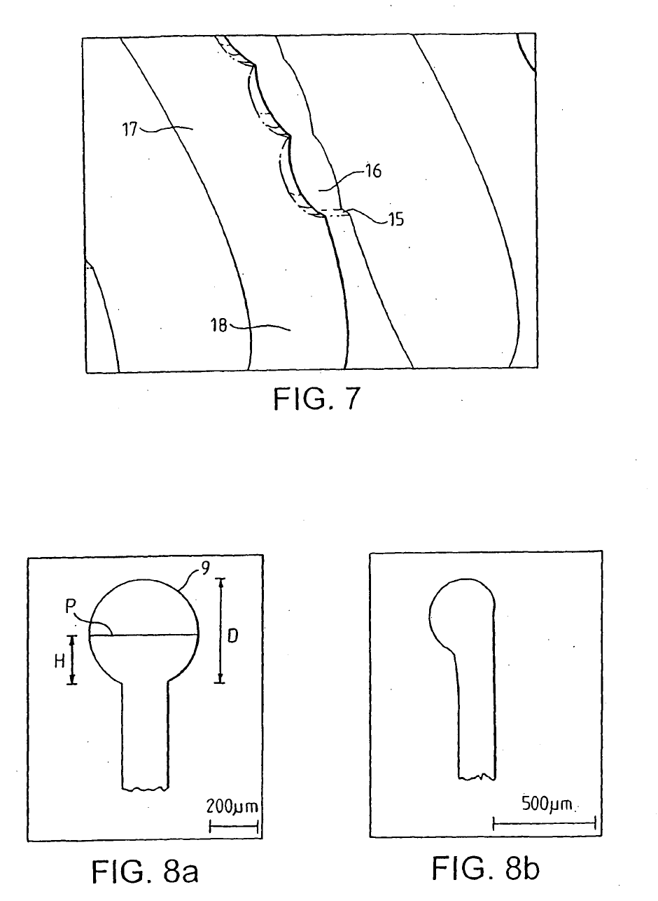

FIG. 7 shows weakness at the start of a weld bead;

FIG. 8 shows the effect of centralising by secondary beam deflection;

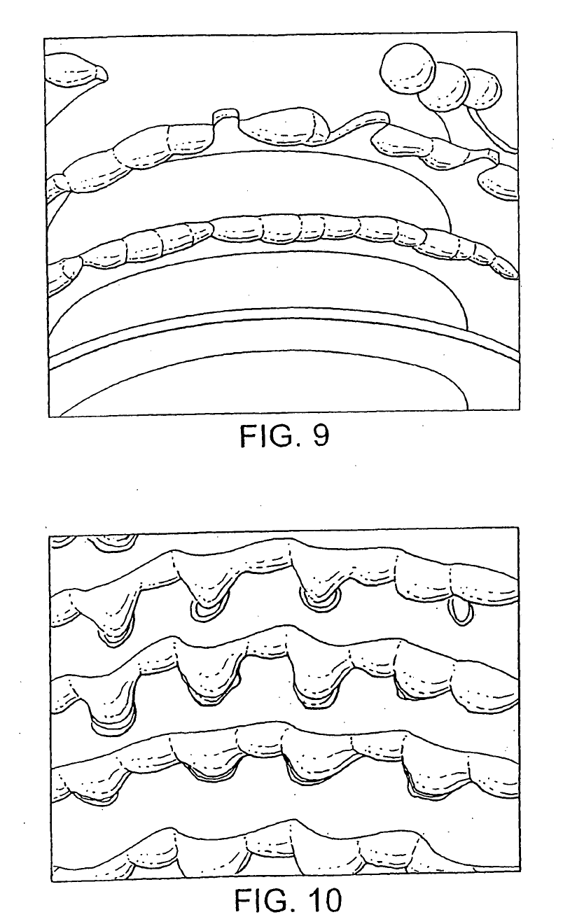

FIG. 9 shows blade damage from excessively high beam energy;

FIG. 10 shows excessive melting of the blade;

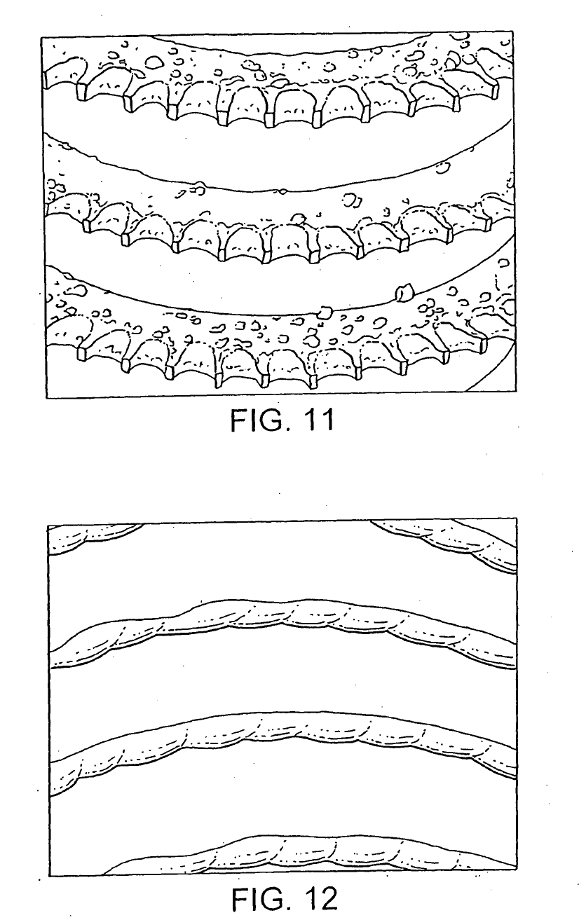

FIG. 11 shows excessive energy and the effect of excessive rotation;

FIG. 12 shows the effect of insufficient melting;

FIG. 13 shows a desirable melting pattern;

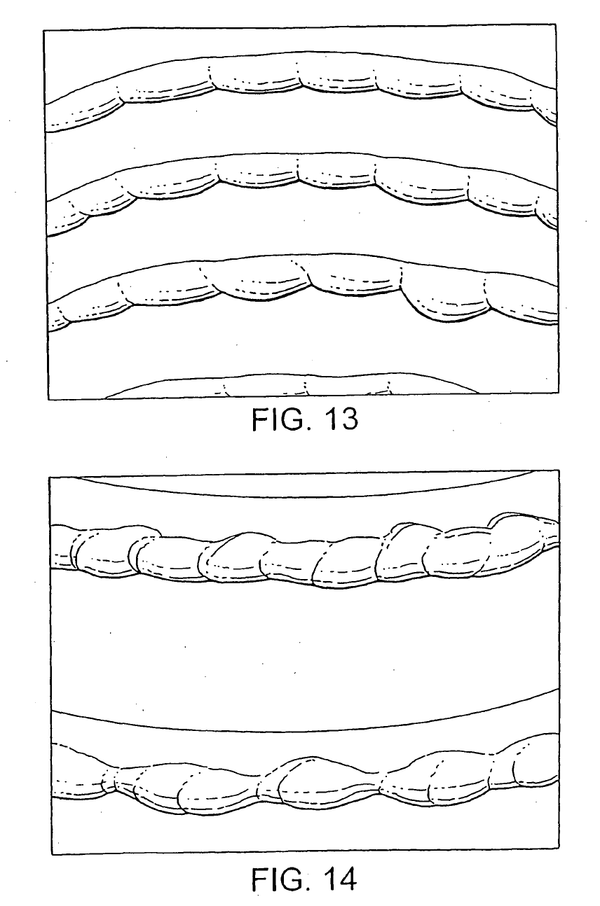

FIG. 14 shows premature coalescence;

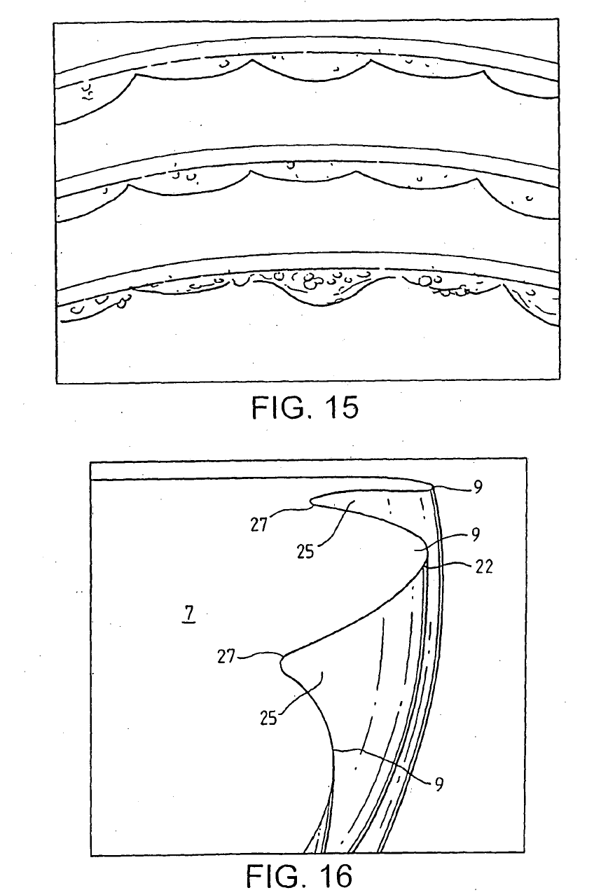

FIG. 15 shows weld beads on a blade edge;

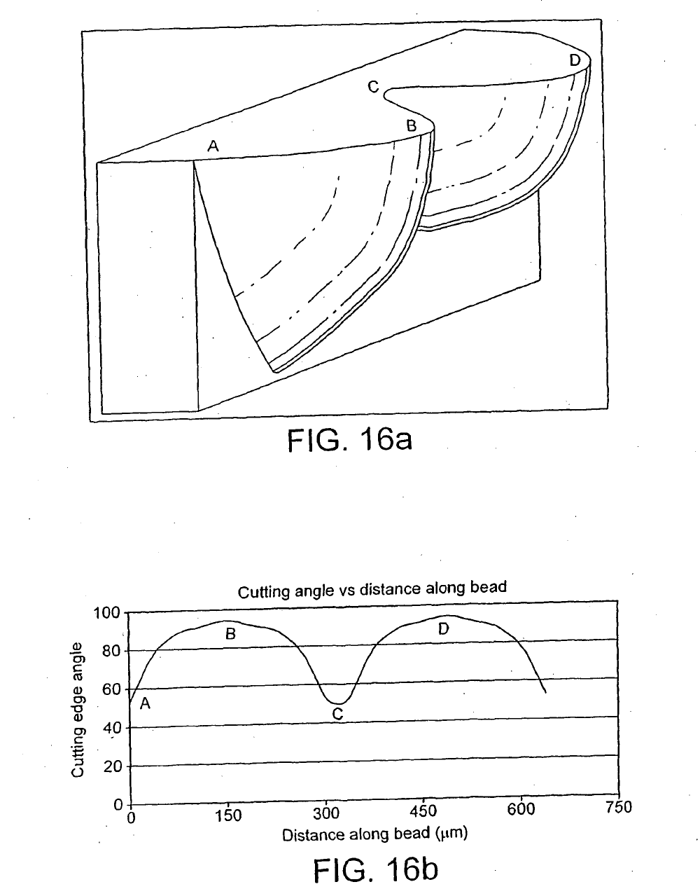

FIG. 16 shows a detail of a blade edge showing the change in edge angle;

FIG. 16a shows a schematic view of a blade cutting edge;

FIG. 16b is a graph of cutting edge angle against distance along the weld bead;

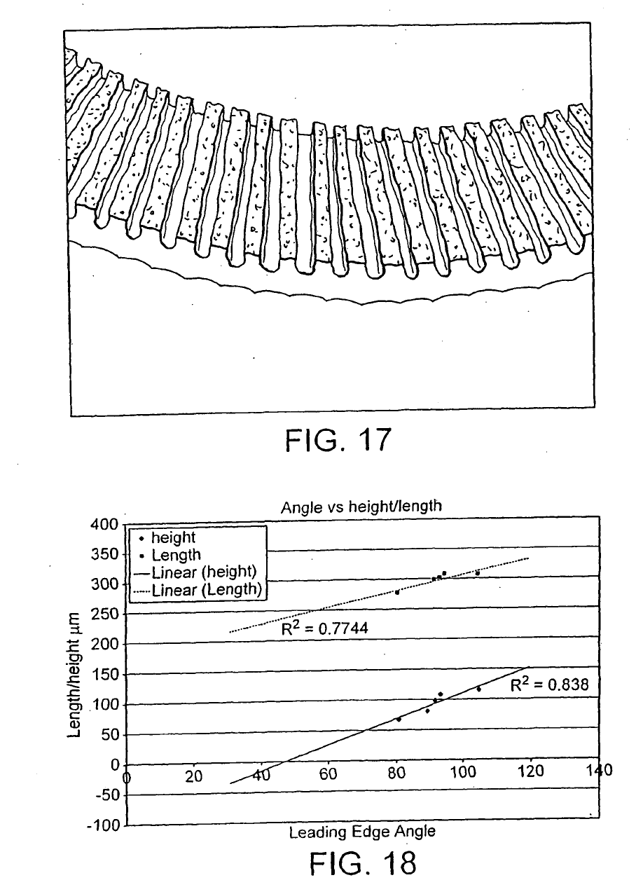

FIG. 17 shows a laser drilled blade edge;

FIG. 18 shows correlation between the leading edge angle and bead length and height;

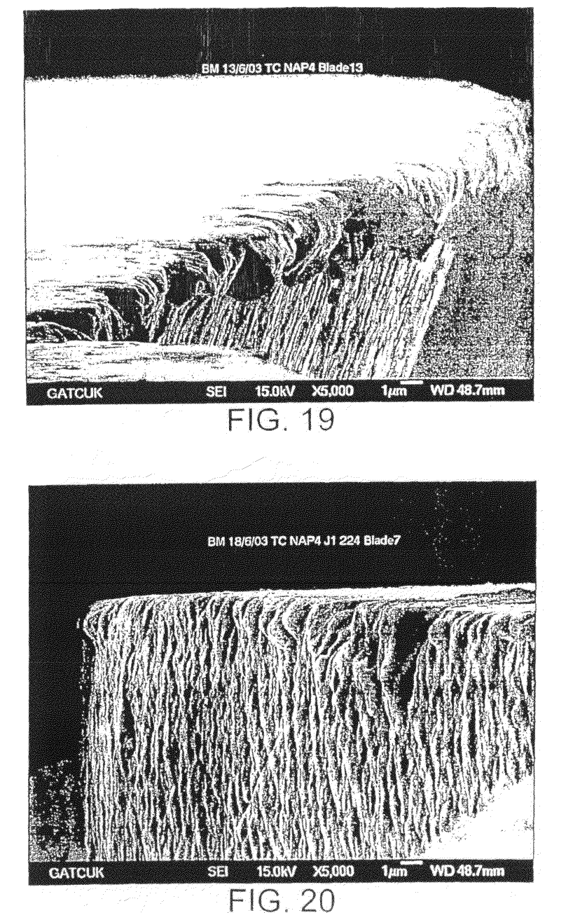

FIG. 19 shows a sharp serrated edge;

FIG. 20 shows a 90° serrated edge;

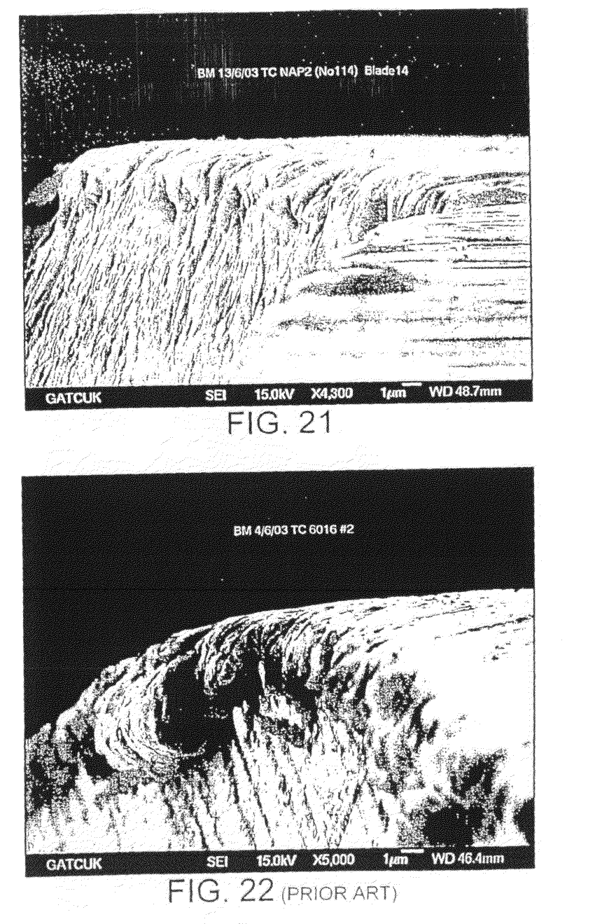

FIG. 21 shows an obtuse edge;

FIG. 22 shows a typical undercutter edge with burr;

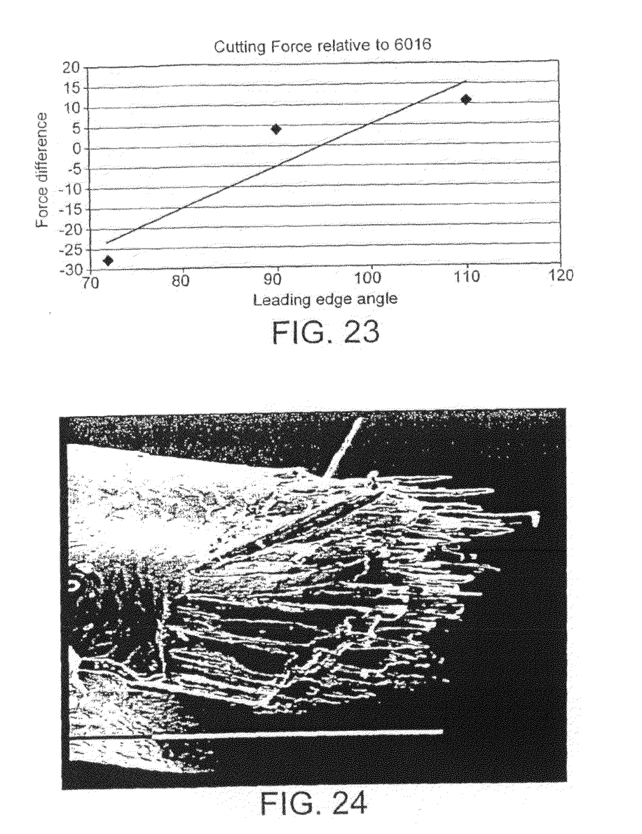

FIG. 23 is a graph of changes in hair cutting forces vs. leading edge angle;

FIG. 24 shows a hair end from conventional dry shaving,

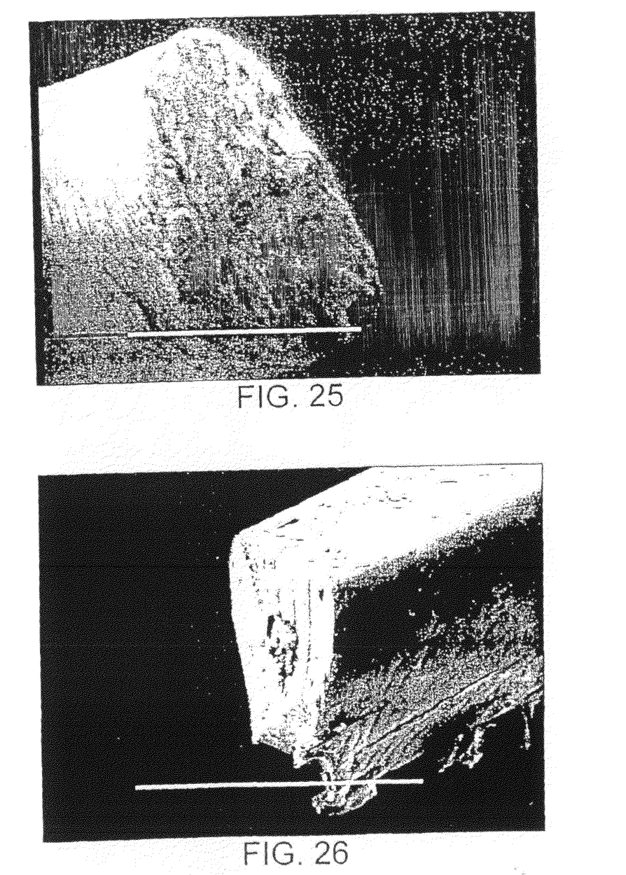

FIG. 25 shows a hair end from a serrated edge cutter; and

FIG. 26 shows a hair end from wet shaving.

This invention employs a serrated or scalloped edge on the undercutter of an electric razor to enhance the shaving performance. This improvement is achieved by promoting hair capture and retention and reducing the cutting forces required to sever the hair. The serrations and/or scallops help retain the captured hair, thereby increasing hair cutting efficiency. They also reduce the tendency for the hair to “roll” along the edge of the foil aperture until it is trapped in the aperture angle; this promotes a closer shave.

A serrated edge can be generated by various methods. In this disclosure, several possible methods are proposed.

The preferred method of fabrication is to generate a weld bead on the outer surface of an undercutter blade and grind back the bead to generate sharp edges along the weld bead. In doing so, the weld bead produces a serrated pattern. The geometry of the serration is determined by the geometry of the weld bead.

The weld bead is generated by a suitable metal melting process, such as electron beam welding. The process of bead formation increases the hardness of the undercutter metal. The solidified weld bead is then ground back to generate a smooth surface that becomes the engagement surface between the foil and the body of the undercutter. When the weld bead is generated it is formed as a series of interconnected globules, but when they are ground back, these globules form a pair of serrated sharp edges. The pitch of the serrations will be dependent on the original size of the globules and the amount of metal removed during the grinding process. The tip angle of the sharp edge will be dependent on the amount of metal removed from the bead. For instance, if the weld bead is ground back to its equator or great circumference, the tip edge angle will be 90°, if it is ground back to only about 20% of the original vertical diameter, the edge angle will be 45°. If the grind back is less than 50% of the vertical diameter, the tip angle will be obtuse.

The scalloped edge has been shown by high speed video to enhance hair capture and to promote closer hair cutting. A comparison between a scalloped edge and a typical linear edge has shown that, under the same test conditions, a typical linear edge will engage a hair in approximately 47% of the blade passes, but the scalloped edge will engage the same hairs in approximately 65% of the passes. With a conventional undercutter, the hair can ride along the blade until it is trapped in the angles around the aperture, but with the scalloped edge, the hair has been shown to be trapped by the scallops and cut at the closest contact edge of the foil aperture. There is also some video evidence of hair extension and cantilever cutting, both of which promote shave closeness and efficiency.

High speed video filming has indicated that about 50% of the hairs cut with the scalloped edged blade are cut against the foil aperture edge as soon as contact is made between the aperture side, hair and undercutter blade. In the case of a conventional linear blade, all hairs are cut in the aperture angle.

The electron welding process may be improved by controlling the weld bead geometry during its formation. This will enable better control of a regular pattern as well as an optimisation of the cutting edge tip angle.

FIG. 1 of the accompanying drawings shows an enlarged view of a portion of a standard undercutter for a dry shaver manufactured by Braun AG. Such a standard undercutter comprises a plurality of annular blade elements. Two such blade elements 1 and 2 are shown in FIG. 1. All the blade elements are substantially identical. Referring to blade element 1, it has first and second major faces, one major face 3 of which is visible in FIG. 1. It also has an annular edge face 4. The intersection between the major surface 3 and the edge face 4 is substantially linear and describes the arc of a circle.

FIG. 2 shows an enlarged view of two blade elements 5 and 6 of an undercutter according to a first embodiment of the invention. Each of the two blade elements 5 and 6 visible in FIG. 2 has an edge face 7, the lateral edges 8 of which exhibit a series of protrusions 9 shaped as serrations or scallops. Accordingly, the interface between each major surface 3 of each blade element and the outer edge 7 describes a plurality of arcuate regions and cusps as shown in FIG. 3. Each protrusion 9 has a length L in the range 290 μm to 310 μm, preferably 300 μm, and a width W of at least 35 μm. Each protrusion will have a height H (perpendicular to the plane of FIG. 3) in the range 60 μm to 120 μm, preferably about 100 μm. FIG. 8a shows schematically a cross-section through a single globule 9 of the weld bead. The globule has a height D and after grind-back to the plane P will have a residual height H, which is thus the height of each protrusion 9. The geometry of the blade edge will be described in more detail hereinafter.

The edge profile of the blade element shown in FIG. 2 can be produced by controlled melting of the outer areas of the blade elements of an undercutter such as that of FIG. 1 in such a way that discrete globules are produced around the circumference of the cutting surface as shown in FIG. 4. These globules are further modified by grinding to produce the scallop-like features with a serrated cutting edge. The controlled melting of the outermost areas of the undercutter can be achieved by using adapted electron beam welding technology in order precisely and locally to melt the undercutter blade edge.

Electron beam welding (EBW) is usually employed as a method of joining together pieces of metal. It is a high energy density diffusion process which uses accelerated electrons with very high velocities. These velocities range between 0.3 and 0.7 times the speed of light and are dependent on the applied voltage, which is usually between 25 and 200 kilovolts. Beam currents may vary between 2 and 1,000 milliamps. Typical beam energy densities are in the region of 10⁷ watts per square centimetre and this can generate welding speeds of between 100 and 5,000 millimetres per minute, depending on the material.

The electrons are produced on a metallic cathode, usually of tungsten or tantalum, which operates under a vacuum of about 10⁻⁴ torr and a temperature of about 2,500° C.

The workpiece is held in a vacuum chamber where the operating vacuum is about 10⁻² torr. However, the level of vacuum in the working chamber will influence the beam intensity and spread (i.e. degree of collimation), so higher vacuums are beneficial for obtaining greater beam resolution. The precision of the beam will be jeopardised by any residual magnetism in the workpiece, because the electron beam is susceptible to deflection and distortion. It is therefore important that the workpiece is demagnetised prior to processing.

One of the main differences between electron beam welding and other high energy welding techniques is the substantially instantaneous conversion of kinetic energy into thermal energy when the electron beam collides with and penetrates the workpiece. The electron beam effects only a small intrinsic penetration of the workpiece and this, combined with the high power density, results in an almost instantaneous melting and vaporisation of the workpiece. Hence, unlike most other welding techniques, in electron beam welding the rate of melting is not limited by thermal conduction. Such high power density can produce temperature gradients of about 10⁶° K/cm and this in turn leads to surface tension driven thermocapillary flow (or Marangoni Convection) with surface velocities in the order of 1 metre per second. Convection is the single most important factor affecting the geometry of the resulting weld pool and can result in defects such as variable penetration, porosity and lack of fusion. Convection also affects mixing and therefore affects the composition of the weld pool.

EBW offers advantages over other techniques. For example, the lower heat input compared with, for example, arc welding results in a better aspect ratio for the heat affected zone and this results in fewer thermal effects in the workpiece.

Weld beading of an undercutter edge is achieved by controlled melting of the top surface of the undercutter with an electron beam welder. Precise control of the beam energy and processing parameters is critical to obtaining a suitable edge.

Correct bead formation is essentially achieved by a proper combination of beam energy, rotational speed of the blade and the correct number of beam-blade interactions (i.e. weld bead formations).

There are up to 18 variables that can be adjusted in the operation of a typical electron beam welder. The actual processing parameters will depend on the characteristics of the individual electron beam welding machine.

Using a standard size Braun undercutter, in one example, the machine was operated to produce 29 weld globules per blade, using 16 W of power for each weld event.

In practice the potential energy of the beam is significantly greater than the energy required to melt the blade edges, so it is feasible to split the beam into a set of “beamlets” with each beamlet traversing one blade of a multi-bladed undercutter. In this way the complete undercutter can be rotated beneath the beamlets and processed in one sweep to produce the structure shown in FIG. 4. Since all the undercutter blades are simultaneously processed, it is essential that the beamlet energies are uniform. If they are not the resulting beaded blades will be of uneven heights and this will jeopardise their successful grind back.

As shown in FIG. 5, undercutter 11 is held in an elongate jig 10 and rotated about its longitudinal axis to cause the electron beam to traverse along the edge of each blade of the cutter. The beam is pulsed during this process to generate a weld bead comprising a succession of weld globules along each blade edge.

The undercutter 11 is mounted onto a shaft 12 and is inserted into the body 13 of the jig. The body 13 has a cut-out section 14. FIG. 6a shows the shaft 12 removed from the body 13. FIG. 6b shows the body 13 without the shaft 12 and undercutter 11.

The undercutter blades are positioned in the cut-out section 14 of the jig. The jig assembly 10 is rotated at a predetermined speed and the electron beam is “struck” on the jig body 13, thereby avoiding localised excessive heating and metal loss on the blades. It also allows the establishment of a thermal equilibrium on the workpiece.

During the beading process, the blade edge is melted, which produces a localised change in structure. The resulting hardness increases to an average of about 755±50 Hv, with a maximum hardness of 790 Hv.

Investigations have shown that the heat affected zone is restricted to the weld bead area and that the original blade material has not changed its structure during the bead forming process. Dendritic and lamellar growths are caused by the solidifying process and their growth is related to the Marangoni Convection characteristics of the alloy steel.

If the beam is initially struck on the undercutter workpiece 11 and excessive metal loss occurs, a localised weakness in the blades can occur as shown in FIG. 7. This may result in blade failure, especially in the later grinding operations. During testing, such failures, if they occurred, were always associated with the same area 15 of the blade 17, as shown in FIG. 7. This weakness is associated with a visible loss of metal at the junction of the first weld globule 16 and the main body 18 of the undercutter, but a factor may also be differential localised heat treatment and subsequent embrittlement. Such a zone is analogous to the “Heat Affected Zone” often seen in conventional welding. Such failures can be overcome by mounting the undercutter in an assembly that leaves the blades exposed, whilst offering a “heat sink” to the beam before and after blade melting. The jig 10 provides such an assembly. This prevents the generation of the weak area at the junction between the blade and the undercutter body.

Centralisation of the weld bead is critical to the successful fabrication of the final product. The location of the weld bead in relation to the undercutter blade is determined by the rate of cooling and the relative location of the electron beam. The rate of cooling is determined, in part, by the Marangoni Convection characteristics of the steel, as well as the precise location of the beam. FIG. 8a shows a correctly centred weld bead, whereas an incorrectly located weld bead is illustrated in FIG. 8b.

The Marangoni Convection characteristics are influenced by the presence of inclusions or impurities, so it is important that any processing material is as free as possible from inclusions or impurities. Of major importance is the lack of non-metallic impurities such as silicates, as these will significantly affect the flowing properties of the weld pool. The location of the electron beam relative to the blade edge is critical. The undercutter blade is only 100 μm thick, so a positional accuracy of better than 50 μm is required to ensure the beam correctly interacts with the metal and the bead formation is successful. This interaction is controlled by the “Primary Beam Deflection”. However, since the inter-blade distances are variable, the beam is also subjected to Secondary Beam Deflection by being transversely “vibrated” across the blade edge. This has the effect of widening the beam transitional length across the blade edge and reducing the effects of varying pitch, thereby centralising the weld bead on the edge. The effect of such Secondary Beam Deflection is shown in FIG. 8a, whereas the result with no Secondary Beam Deflection Is shown in FIG. 8b.

The control of the fundamental operating conditions is also essential to good bead formation. If the undercutter blades are exposed to energy which is too high, excessive melting will occur, resulting in blade disintegration as shown in FIG. 9.

Very excessive beam energy results in total melting of the undercutter blades, but only a marginal excess of energy can result in weld bead flow away from the blade edge (FIG. 10). This will result in an unacceptable amount of metal loss being required to achieve an edge on the undercutter. It will also result in an increased probability of removing the serrated edge entirely during the grind back of the weld bead, since there will be a lack of weld bead uniformity.

Excess beam energy cannot be compensated for simply by increasing the rotation speed as this will reduce the number of weld globules generated and will result in gaps between the globules and ultimately between the final serrations. A combination of excessively high rotation speed and high energy is manifested as undesirable raised areas between the weld globules, as shown in FIG. 11.

It is currently not possible to alter the discharge period of each electron beam “pulse” as the discharge is virtually continuous.

If insufficient energy is imparted to the weld bead, there will be inadequate melting and the weld bead will be too small to generate a good edge profile, as shown in FIG. 12.

A satisfactory weld bead formation is represented by a smooth outer surface and consistent flow pattern at the base of the weld pool, as shown in FIG. 13.

For a successful “string of beads” to be generated around a blade edge, it is essential that each globule should solidify before the next globule is generated, or coalescence can occur. If the number of globules is too high, the weld pools can combine before solidification, resulting in excessive flow of the molten metal and subsequent distortion of the weld bead pattern as shown in FIG. 14.

The beaded undercutters may be inspected by scanning electron microscopy to ensure the bead formation is suitable and adequate for further processing.

The serrated edge was generated in one particular example by non cylindrical surface grinding of the weld bead using a 60-80 μm grit grinding wheel with a 3 mm radius formed into it. To prevent blade fracture during this operation, the undercutter may be filled with Thermojet™ 3D rapid prototyping wax. After grinding, the wax may be removed by heating it with a hot air drier.

The ground undercutters were then lapped using 6 μm diamond paste and finally inspected for suitability.

The new undercutters may be fabricated from conventional undercutter material as supplied by Braun GmbH. This is 1.4034 stainless steel (equivalent to BS 420 and X40Cr13) and has the following composition:

| | | |
|---|---|---|
| C | 0.40-0.46 | wt. % |
| Si | 0.3-0.5 | wt. % |
| Mn | 0.4-0.6 | wt. % |
| P | 0.03 | wt. % |
| S | 0.02 | wt. % |
| Cr | 12.5-14.5 | wt. % |
| Fe | balance | wt. %. |

The steel is heat-treated to a hardness of 650±50 Hv prior to weld-beading.

Since the weld globules are non-symmetrical and more similar to ovoids than spheres, the grinding process produces a flattened top surface and a varying angled curve around the rim, as shown in FIGS. 15 and 16.

Furthermore the globules are somewhat elongated along the circumference of the blade edge, so the maximum globule height is less than half its length and the edge angle becomes more acute towards the original blade edge, in the valleys formed between successive protrusions. This is clearly shown in FIGS. 16, 16a and 16b.

FIG. 16 shows a succession of three lateral protrusions 9 along a blade edge which has been ground flat along its outer edge 7. Valleys 25 are thus created between successive pairs of protrusions. When moving from the peak 22 of each protrusion 9 towards the floor of each valley 25, the blade angle becomes progressively sharper and more acute. An acute cutting edge 27 is thus produced at the foot of each valley wall, and this edge becomes progressively less acute when moving up the valley wall towards the peak 22. The angle varies from about 90° at the leading edge or peak 22 of each protrusion to a sharper edge 27 of about 55° at the valley floor.

The geometry of the blade cutting edge will be more clearly understood from FIGS. 16a and 16b. FIG. 16a shows a schematic representation of the cutting edge extending along a first arcuate section from A to B, a second arcuate section from B to C and a third arcuate section from C to D. FIG. 16b shows how the blade cutting edge angle varies continuously and smoothly as a function of distance along the weld bead, as measured along a straight line intersecting points A and C. It will be noted that in the region of point A the cutting edge angle is about 50° and increases continuously and smoothly as point B is approached to a maximum value of about 95°. The cutting edge angle then decreases continuously and smoothly as point C is approached, to a minimum value of about 50°.

This variation of angle is achieved because the protrusions are much bigger in length than in height, i.e. the dimension L (FIG. 3) is much greater than the dimension H (FIG. 8a).

The length L (distance A-C in FIG. 16a) should be about 300 μm (400 μm), the width W (distance from line AC to point B) about 40 μm and the height H about 90 μm. Thus L≈3H. It should also be noted that the cutting angle also varies with the vertical location throughout the height of the protrusion, so that the surface of the protrusions may be said to possess compound curvature.

Since the cutting edge is two dimensional (parallel and transverse to the direction of undercutter movement), its cutting process can be considered as a combination of both shear and slice. Conventional dry shaving linear undercutters use a substantially pure shearing action to produce the well recognised “nibbling” action most commonly seen in dry shaving.

The size of the serrations was generated with due consideration for the approximate geometry of hair. The serration length (or pitch) should be such that a hair can fit into, and be retained in, the recessed areas (valleys) of the edge. Furthermore, the width (or amplitude) of the serration should be such that it can retain the hair without adversely affecting the hair penetration into the cutting zone.

Furthermore, the leading area of each curved undercutter protrusion can manage any hair and skin that penetrates the foil aperture, thereby offering protection against excessive exfoliation. It can also provide a mechanism by which the penetrating hair can be oriented into a preferential cutting position.

Further possible manufacturing methods might include:

laser beam welding in place of electron beam welding; blank stamping and deforming metal strips using 3-D press tools; blank stamping individual blades e.g. in strip form using 3-D press tools; wire sparking; electroforming; powder injection moulding or YAG laser profiling.

In the case of YAG laser profiling, the undercutter blade is drilled by YAG laser to produce the required pattern from the outer running surface towards the centre of the cutter. This produces a scallop-shaped edge with a 90° blade angle. The scallops are embedded in the blade face perpendicular to the foil. The pitching of the scallops should be of similar magnitude to the cross-section of a beard hair and is between 50 μm and 250 μm. The amplitude is approximately half the pitch.

An undercutter with thicker blades (250-300 μm) may be laser profiled on both sides to give a scalloped pattern with a pitch of 150 μm and (preferred) amplitude of 100 μm. The increased thickness is required to ensure the laser drilling does not break through the blade or leave it too weak for use. A resulting undercutter blade is shown in FIG. 17, and is referred to hereinafter as a “laser drilled” blade.

The laser cut serrated edge process may be improved by optimising the pitch and amplitude of the scallops and by ensuring the surface of the scallops is made smooth after laser cutting.

The fabrication of serrated edge undercutters has been described above. In summary, the undercutter is preferably produced by controlled melting of the outer circumference of a conventional Braun Flex Integral UltraSpeed electric razor undercutter, generating a weld bead of slightly increased hardness (755 Hv as against 650 Hv for a standard undercutter). The weld bead can be ground back by non-cylindrical off set grinding to produce a smooth serrated edge.

Since significant amounts of metal are removed from the undercutter, the diameter is reduced. For test purposes, to ensure the undercutter fitted the underside of the electric razor foil, it was mounted on a plastic carrier and packed out to achieve the correct overall height. Since the undercutters had been processed by off-set grinding, there was only a minimal change to the foil/undercutter interacting geometry. The primary shaving area of a standard Braun Flex Integral UltraSpeed electric razor is the three aperture rows either side of the foil top centre line. This is maintained with the serrated edge undercutter, but the “fall away” between this undercutter and the underside of the foil outside this area is slightly increased. This marginal change was not considered detrimental to its performance as much of a standard undercutter blade is not in contact with the foil and the actual change in geometry caused by off-set grinding was minimal.

The effects of the geometry of the serrated edge on the performance of the undercutter in an electric razor are discussed below.

Once mounted, the spring loadings (“pre-loads”) were checked and adjusted to match those of the standard Braun Flex Integral UltraSpeed test razor.

The geometry of the scallops was selected to accommodate the typical geometry of a human hair, which was assumed to be approximately elliptical, with axes of about 60-80 μm on the minor and 100-120 μm on the major axis.

The detailed geometry of the serrated edge can be correlated with shaving performance. The degree of post beading fabrication influences the final serration geometries and therefore, for any given bead, the geometries and dimensions will be inter-related.

The number of potential globules was limited to a maximum of 29 on each blade edge only by the manufacturing path and the processing equipment. This, in turn, determined the optimum average length of the bead globules and limited it to about 289-325 μm, depending whether the beading occurs over 180° or 160° of the blade circumference. If the average globule length is less than about 275 μm, the bead string becomes discontinuous, resulting in areas where the cutting edge is effectively the original standard 90° undercutter blade edge. FIG. 18 shows the correlation between the averages of the leading edge angles and the lengths and heights of the weld globules.

With other equipment, up to 35 or so globules could be produced.

The correlation coefficients for the trends in FIG. 18 are above the 95% confidence level; the correlation coefficient (R²) for 6 data sets at the 95% confidence level is 0.6577; those shown in FIG. 18 are 0.7744 and 0.838. It can therefore be expected that if the shaving performance of the undercutters is determined by the bead geometry, there will be numerous interrelations between various shave performance criteria and the geometries.

The performances of different serrated undercutter geometries were assessed against standard undercutters in Braun Flex Integral UltraSpeed razors. FIGS. 19-21 show scanning electron micrographs of the different angles on the serrated edges. For comparison, FIG. 22 shows a typical edge of the Braun Flex Integral UltraSpeed.

It can be seen that the grinding and lapping processes used to produce the final edges create a burr of a few microns in diameter attached to the edges. These burrs are smaller than those normally associated with the unused edge of the standard undercutter, as shown in FIG. 22.

However, as far as the geometry of the serration and shave performance relationship is concerned, the quantitative feature is the “larger scale” angle between the undercutter edge and the topmost surface. This angle is influenced by the burr geometry. Burr formation is caused during the grinding of the topmost surface of the undercutter and is not directly related to the weld bead geometry. Performance data obtained from the shave tests shows there to be an optimum leading edge angle; for simplicity, this angle is taken from the forward-most point of the serration and includes the “macro-geometry” of the burr.

In practice, there is a range for each nominal leading edge angle and this provides an envelope for the preferred angle values. The preferred value for optimum closeness is 92° and preferably between 86° and 100°, although benefit will generally be seen by the average user if the leading edge angle range is between 82° to 104°. However, other benefits can be obtained by having the leading edge angles as high as 107° and as low as 78° as this range can accommodate requirements for customers requiring either a more or less aggressive shaving system.

Shaving efficiency is again maximised at a leading edge angle of about 92° and decreases towards parity with the control cutter as the angle deviates from this value. For best performance, this angle should be held between 87° and 97°. However, benefit will still be maintained if the range is increased to between 80° and 105°; geometries beyond this range may jeopardise the performance of the undercutter. If this angle becomes too obtuse, the edge becomes less effective at cutting, whilst if it becomes more acute, there is an increased risk of discomfort caused by the sharp edge.

Benefit in the time to shave is obtained if the leading edge angle is less than 104°, although the range at which no benefit is perceived is shown to be between 98° and 107°. This range accommodates users who prefer either more aggressive or more passive shaves. To ensure all users perceive a benefit, it is therefore reasonable to limit the leading edge angle to less than 98°, but higher angled undercutters could be offered to customers requiring a more passive shave.

It has proved that the width of the serrations has only a marginal effect on the performance of the serrated edge undercutter when compared against the standard Braun Flex Integral UltraSpeed. However, for a performance benefit, the serration should be at least 35 μm wide.

To ensure the performance of the undercutter edge is not jeopardised, the serration height should be between 60 μm and 120 μm, with a target of 100 μm.

There is no strong correlation between undercutter performance and the length of the serrated edge protrusions. However, there is a suggestion that if the length is reduced to below about 250 μm, the general performance of the undercutter is adversely affected and can even perform worse than the standard control undercutter. This can be explained by the loss of the serrations as the cutting edge regresses towards the geometry of the standard control undercutter. The benefits of the serrated edge are therefore progressively diminished until any benefits achieved in enhanced hair capture and/or severance are forfeited by the localised loss of the serrated edge.

It is possible to estimate the target geometry for the serrated edge. The following parameters can be determined:

TABLE 1
Preferred processing parameters

| | | | |
|---|---|---|---|
| Parameter | Target | Maximum | Minimum |

| Average angle | 92° | | 100° | | 86° | |
|---|---|---|---|---|---|---|
| Serration width | 35+ | μm | N/A | | 30 | μm |
| Serration | 100 | μm | 120 | μm | 60 | μm |
| height | | | | | | |
| Serration | 300 | μm | 310 | μm | 290 | μm |
| length | | | | | | |

The target average leading edge angle (92°) was initially unexpected. However, the shape of the serration is such that the cutting edge angle decreases as the hair traverses the serrated edge towards the undercutter blade body. A modest obtuse angle at the initial point of any undercutter blade/skin interaction would result in enhanced comfort. Furthermore, the shape of the current beads prior to grind-back is such that the generation of obtuse angles is much easier than acute ones, so the leading edge angle distribution is skewed towards higher angles. In practice, an average leading edge angle of 90° would almost certainly perform as well as the slightly obtuse 92°. The preferred length of the serration is determined by the electron beam characteristics and in reality is outside the variable processing parameters. The width and height of the serrations is dependent on the overall geometry and is related to both the bead forming process and leading edge angle. Whilst these two characteristics help define the final serration shape, they have only a secondary effect on the final performance of the undercutter.

A direct comparison was made between the wear characteristics of a serrated edge undercutter and a standard undercutter under the same conditions. It was found that the serrated edged undercutter did not have any adverse characteristics when compared with the standard control undercutter and furthermore the serrated edge maintained a sharp burred edge, whilst the control undercutter underwent apparent metal deformation. Nickel was lost from the underside of the razor foil by abrasive wear and only lightly adhered to the surface of the undercutter blades. There was no evidence of nickel accumulation in the undercutter surface or the burrs.

The cutting force for different pre-selected leading edge angles for the serrated edge undercutter was compared against those for a standard control undercutter. Each leading edge angle data set was obtained from the same hair strand and to minimise effects due to variations in the intra-hair thickness, values for the serrated edge were taken alternately to the standard undercutter.

Table 2 shows the cutting forces obtained:

However, the end of hair cut by the serrated edge undercutter shows a much smoother cut surface, as shown in FIG. 25, with very little evidence of cortical fibrils.

For comparison, a hair end produced by a Mach3™ blade is shown in FIG. 26. A comparison of FIGS. 24-26 confirms that the serrated edge undercutter can produce cutting actions more similar to the wet shave slicing than the typical dry shave shearing.

High-speed video analysis has shown that the blades of the serrated edge undercutter appear to be more rigid than their standard control undercutter counterparts. It has been shown that the standard undercutter blades flex when interacting with hair, but this is not so evident with the serrated edge. This is probably due to the increased blade width and increased hardness in the serrated edge undercutter at the point of interaction between the foil, undercutter and hair.

The serrated edge undercutter can have an almost identical shearing action as a conventional linear bladed undercutter when it interacts with a hair and the aperture edge. However, the serrated edge can also promote hair slicing by the progressively decreasing edge angle slicing through the hair as it interacts with the aperture edge.

Furthermore, beard hair can be trapped by the serrations and shepherded into the recesses along the blade edge. This allows the trapped hair to be cut in a three-edge action by the edges of two adjacent serrations when the hair and undercutter interact with any part of the foil aperture edge. The serration recesses therefore act as another engaging angle and behave as if they are another aperture entrapment angle. This would not be possible with a conventional linear edged undercutter as cutting relies on the hair being trapped in the aperture angles.

An analysis of undercutter-hair interactions where the hair was severed shows that all three processes occur, as in Table 3.

TABLE 3
Hair cutting mechanisms.

| Process | No. hairs | % total hairs |
|---|---|---|
| Held | 14 | 45 |
| “Shepherded” | 5 | 16 |
| Standard style | 12 | 39 |
| cutting | | |

TABLE 2
Cutting forces.

| Cutting | Serrated | Standard | Difference | Standard | % |
|---|---|---|---|---|---|
| angle | edge (g) | (g) | (g) | Deviation | difference |
| 72° | 133.28 | 161.10 | −27.82 | 38.55 | −17.3 |
| 90° | 153.84 | 149.73 | 4.11 | 39.94 | 2.7 |
| 110° | 145.42 | 134.52 | 10.90 | 30.48 | 8.1 |

The difference in cutting forces for varying angles is shown in FIG. 23.

A leading edge angle of 72° can reduce the average cutting force of a hair by about 17% when compared against a standard undercutter. On the other hand, if the leading edge angle is too obtuse (110°), the average cutting force can increase by about 8%.

It can be seen in FIG. 23 that the leading edge angle for no difference in cutting force between the control undercutter and a serrated edge is about 95°. This is can be attributed to the effects of the rounded edge and burrs on the standard control undercutter blades giving an effective cutting angle different to the target angle.

These observations further suggest that the actual cutting edge of a standard run-in undercutter is influenced by the burr and that it has an effective cutting angle of 95°. Closer examination of standard undercutters has revealed the burr to generate an effective leading edge angle of between 95 and 104°. Furthermore, this correlates to a burr of approximately 5-8 μm in diameter. These data are very similar to other observations related to burr formation.

It has also been observed that obtuse angle cutting can result in hair skiving, where the hair is not fully cut and the cutter runs longitudinally along the hair to leave a long taper.

Scanning electron microscopy examination of the ends of hairs that have been cut using the serrated edge undercutter has shown not only evidence of a slicing action similar to that seen in wet shaving, but also the conventional shearing usually associated with dry shaving.

FIG. 24 shows a hair end from a conventional dry shaving cut and it can be seen that the cortical fibrils are very much in evidence as a ragged end.

Conventional standard hair cutting relies on the hair being trapped in an aperture corner and being cut by the passing undercutter blade and this has been seen in 39% of cutting actions. However, the serrated edge undercutter can cut a hair at any point on the aperture rim and this has been seen in 45% of the cutting actions. Furthermore, the serrated edge can “shepherd” the hair around its contours to trap it in the serration recesses and then cut it against any part of the aperture edge. This has been seen in about 16% of the interactions. A comparative high speed video examination of the cutting processes seen with a standard undercutter showed all cuts to occur in the angle of the hexagon.

A serrated edged undercutter produced by generating a weld bead by an electron beam and grinding back the bead to produce a three dimensional cutting edge with a flat top surface is superior in shave performance to a standard Braun undercutter. The new undercutter can deliver statistically superior performances in various dry shaving attributes.

The serrated edge undercutter has an increased hardness that provides a more robust edge with a smaller burr. This modified edge does not have any adverse effect on the tribological interactions between the foil and undercutter.

The preferred geometry for the serrated edge produced by the electron beam system has been identified as being a weld bead, having globules of about 300 μm in length, that is continuous about the cutting face of the undercutter. The height of the bead should be about 100 μm and the width from the original blade edge should be about 30-40 μm. This geometry produces a leading edge cutting angle of about 92°. The leading edge angle is more obtuse than the edge angles generated between the ground and finished weld beads, and cutting forces are reduced by the implementation of sharper edges.

Furthermore, scanning electron micrographs have shown the cut ends from a serrated edge undercutter to exhibit surfaces more similar to a conventional wet shaving slicing than dry shaving shearing.

High speed video examination of the interactions between the shaving system, skin and hair have shown that the serrated edged undercutter can sever hair by not only conventional shearing, but also by slicing the hair. Furthermore, the serrated edge can “shepherd” hair so that non-conventional cutting is achieved thereby improving cutting efficiencies. The serrated edge may also provide superior skin management that reduces the possibility of undercutter-skin interactions and the resulting Post Shave Soreness. It has also been shown that the serrated edge undercutter does not flex as much as a standard control undercutter when encountering a hair.

### LIST OF REFERENCE NUMBERS

Blade elements 1, 2
Surface 3
Edge face 4
Blade elements 5, 6
Edge face 7
Lateral edge 8
Lateral protrusions 9
Jig 10
Undercutter 11
Shaft 12
Body 13
Cut-out section 14
Area 15
Weld globule 16
Blade 17
Main body 18
Peak of lateral protrusion 22
Valley 25
Valley floor 27

What is claimed is:

1. An undercutter for a dry shaver comprising a plurality of blade elements (5,6), each having a blade element edge (7), wherein at least one blade element edge (7) has a plurality of successive lateral protrusions (9) defining valleys (25) therebetween, and an acute cutting edge (27) within each valley.

2. An undercutter according to claim 1, wherein the successive lateral protrusions define a cutting edge (27) extending along a periphery of the successive lateral protrusions, said cutting edge (27) having an acute cutting angle in regions adjacent each said valley.

3. An undercutter according to claim 2, wherein the cutting angle is greatest at the apex of each protrusion and smallest at the regions adjacent the floor of each valley.

4. An undercutter according to claim 3, wherein the cutting angle changes continuously from the greatest angle to the smallest angle.

5. An undercutter according to any preceding claim, wherein each protrusion has a surface with compound curvature.

6. An undercutter according to any preceding claim, wherein each said valley provides a respective hair-trapping region.

7. An undercutter according to any preceding claim, wherein the blade angle at the peak (22) of each lateral protrusion lies in the range 85° to 105°.

8. An undercutter according to claim 7, wherein the blade angle at the peak (22) of each lateral protrusion is about 92°.

9. An undercutter according to any preceding claim, wherein the height (H) of each protrusion is in the range 60 μm to 120 μm.

10. An undercutter according to claim 9, wherein the height (H) of each protrusion is about 100 μm.

11. An undercutter according to any preceding claim, wherein the width (W) of each protrusion is about 35-45 μm.

12. An undercutter according to any preceding claim, wherein the length (L) of each protrusion is in the range 290 μm to 310 μm.

13. An undercutter according to claim 12, wherein the length (L) of each protrusion is about 300 μm.

14. A cutter assembly for a dry shaver, comprising:
an outer cutter having a plurality of hair receiving apertures; and
an undercutter according to any preceding claim mounted for movement relative to the outer cutter and having a plurality of blade elements (5,6).

15. A method of producing a sharp undercutter having at least one blade comprising:
providing at least one undercutter blade (5,6) having an edge region;
subjecting the edge region (7) of at least one undercutter blade to electron beam welding to generate a weld bead comprising plurality of successive globules (16) along the edge region; and
grinding back the weld bead to produce a generally smooth edge (7) having a plurality of lateral protrusions (9) and acute cutting edges (27) in valleys therebetween.

16. A method according to claim 15, in which the successive lateral protrusions define a cutting edge (27) extending along a periphery of the successive lateral protrusions, said cutting edge (27) having an acute cutting angle in regions adjacent each said valley.

17. A method according to claim 15 or 16 in which said blade edge is provided with globules (16) having an average length in the range of 280-325 μm.

18. A method according to claim 15, 16 or 17 in which about half the material of each globule (16) is ground away.

19. A method according to any one of claims 15 to 18 in which an undercutter assembly having a plurality of blades (5,6) is subjected to electron beam welding to generate a weld bead comprising a plurality of globules (16) along the edge region of each blade.

20. A method according to claim 19 in which the blades of said plurality are processed simultaneously.

21. A method according to claim 19 or 20 in which said undercutter assembly is held in a heat-sink (10) when subjected to electron beam welding.

22. A method according to claim 21 in which said heat-sink (10) is rotated during the welding process.

23. A method according to claim 21 or 22 in which said undercutter assembly is held in a tubular heat-sink (10) during welding.
